(19) United States
(12) Patent Application Publication
(10) Pub. No.: US 2015/0355441 A1
(43) Pub. Date: Dec. 10, 2015

(54) OBJECTIVE LENS ASSEMBLY HAVING CATADIOPTRIC GROUP

(71) Applicant: SAMSUNG ELECTRONICS CO., LTD., Suwon-si (KR)

(72) Inventors: Tae-Joong KIM, Hwaseong-si (KR); Kwang-Soo KIM, Pyeongtaek-si (KR); Wook-Rae KIM, Suwon-si (KR); Young-Kyu PARK, Incheon (KR); Byeong-Hwan JEON, Yongin-si (KR); Kohei HASHIMOTO, Suwon-si (KR)

(21) Appl. No.: 14/630,126

(22) Filed: Feb. 24, 2015

(30) Foreign Application Priority Data
Jun. 10, 2014 (KR) 10-2014-0070356

(51) Int. Cl. G02B 17/08; G02B 27/00

(52) U.S. Cl. CPC G02B 17/0856; G02B 27/0025

(57) ABSTRACT

An objective lens assembly includes a catadioptric group, a first refractive lens axially aligned with the catadioptric group, and a focusing lens axially aligned with and between the catadioptric group and the first refractive lens. The focusing lens is an aspheric lens.

### CROSS-REFERENCE TO RELATED APPLICATION

Korean Patent Application No. 10-2014-0070356, filed on Jun. 10, 2014, in the Korean Intellectual Property Office, and entitled: “Objective Lens Assembly Having A Catadioptric Group,” is incorporated by reference herein in its entirety.

### BACKGROUND

1. Field

Embodiments relate to an objective lens assembly having a catadioptric group.

2. Description of Related Art

Semiconductor device manufacturing apparatuses have an objective lens assembly. The objective lens assembly may include a catadioptric group for achieving high resolution. Research has been conducted to effectively compensate chromatic aberration and monochromatic aberration of the objective lens assembly having high resolution.

### SUMMARY

One or more embodiments are directed to an objective lens assembly includes a catadioptric group, a first refractive lens located on an optical axis of the catadioptric group, and a focusing lens located between the catadioptric group and the first refractive lens. The focusing lens is an aspheric lens.

The focusing lens may include a first lens surface facing the first refractive lens and a second lens surface facing the catadioptric group. The second lens surface may be an aspheric surface.

Refractive indexes of the first refractive lens over a wavelength range may be different from refractive indexes of the focusing lens over the wavelength range.

The objective lens assembly may further include a second refractive lens located between the first refractive lens and the focusing lens. The refractive indexes of the second refractive lens over the wavelength range may be different from the refractive indexes of the first refractive lens over the wavelength range.

The catadioptric group may include a flat mirror spaced apart from the focusing lens, a hemispherical mirror located between the focusing lens and the flat mirror, and a first catadioptric group lens located between the flat mirror and the hemispherical mirror. The first catadioptric group lens may be an aspheric lens.

The refractive indexes of the first catadioptric group lens according to wavelengths may be different from the refractive indexes of the focusing lens over the wavelength range.

The catadioptric group may further include a second catadioptric group lens located between the hemispherical lens and the first catadioptric lens.

One or more embodiments is directed to an objective lens assembly that includes a focusing lens including a first lens surface and a second lens surface opposite to the first lens surface, a refractive lens group including refractive lenses located above the first lens surface of the focusing lens, and a catadioptric group located above the second lens surface of the focusing lens. A radius of curvature of the second lens surface in an edge portion of the focusing lens is different from a radius of curvature of the second lens surface in a center portion of the focusing lens.

The catadioptric group may include a plano-convex lens having a convex lens surface facing the focusing lens and a flat lens surface opposite to the convex lens surface, a flat mirror disposed on the flat lens surface of the plano-convex lens, and a hemispherical lens disposed between the focusing lens and the convex lens surface of the plano-convex lens. A radius of curvature of the convex lens surface in an edge portion of the plano-convex lens may be different from a radius of curvature of the convex lens surface in a center portion of the plano-convex lens.

One or more embodiments is directed to an objective lens assembly that includes a catadioptric group, a refractive lens axially aligned with the catadioptric group, and a focusing lens aligned with and between the catadioptric group and the refractive lens. The refractive lens and the focusing lens output an intermediate image that is substantially corrected for chromatic aberrations over a wavelength range and monochromatic aberration. The catadioptric group outputs a real image that is substantially corrected for chromatic aberrations over the wavelength range and monochromatic aberration.

At least one lens in the catadioptric group may have a first refractive index, the refractive lens may have a second refractive index, and the focusing lens may have a third refractive index, the first to third refractive indexes being different over the wavelength range.

The refractive lens may be part of a refractive lens group including at least two refractive lenses, at least two refractive lenses of the refractive lens group having different refractive indexes over the wavelength range.

At least one surface of the focusing lens may be aspheric and at least one surface of a lens of the catadioptric group may be aspheric.

An aspheric surface of the focusing lens may face an aspheric surface of the catadioptric group.

### BRIEF DESCRIPTION OF THE DRAWINGS

Features will become apparent to those of skill in the art by describing in detail exemplary embodiments with reference to the attached drawings in which:

FIG. 1 illustrates a schematic configuration of an objective lens assembly in accordance with an embodiment;

FIG. 2 illustrates a graph showing refractive indexes vs. wavelengths for each lens of an objective lens assembly in accordance with an embodiment;

FIG. 3A illustrates a focusing lens of an objective lens assembly in accordance with an embodiment;

FIG. 3B illustrates a view partially showing a first catadioptric group lens of on objective lens assembly in accordance with an embodiment;

FIG. 4 illustrates a view partially showing a first catadioptric group lens of an objective lens assembly in accordance with another embodiment;

FIG. 5 illustrates a schematic configuration of an objective lens assembly in accordance with another embodiment; and

FIG. 6 illustrates a schematic configuration of a semiconductor manufacturing apparatus including an objective lens assembly in accordance with an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

It will be understood that, although the terms “first,” “second,” etc., may be used herein to describe various elements or components, these elements or components should not be limited by these terms. These terms are only used to distinguish one element from another. Therefore, a first element or a first component could be termed a second element or a second component within the scope of the disclosure.

The terminology used herein to describe embodiments herein is not intended to limit the scope of the disclosure. The use of the singular form in the present document should not preclude the presence of more than one referent. In other words, elements referred to in the singular may number one or more, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Embodiments

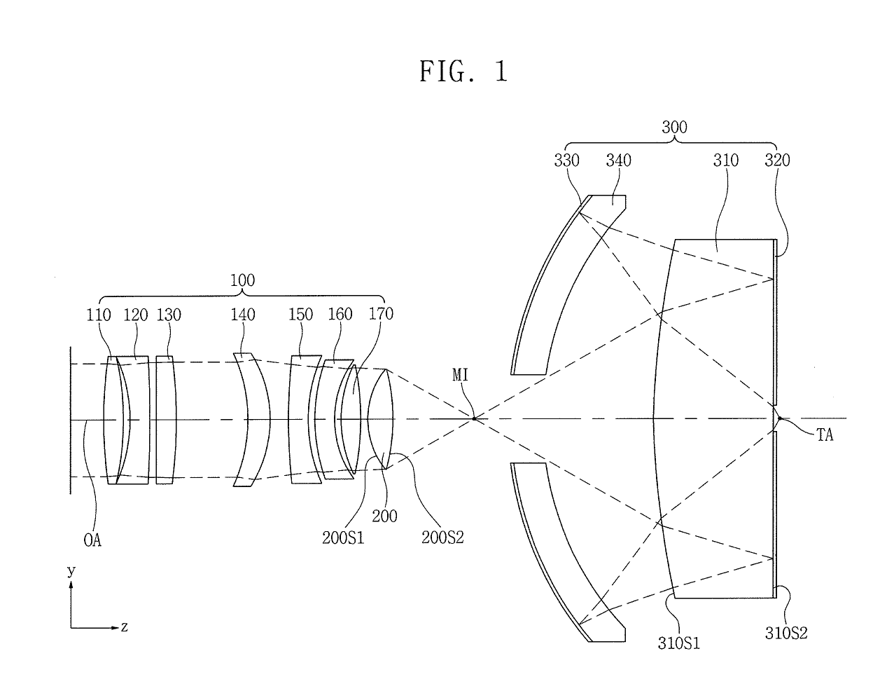

FIG. 1 illustrates a schematic configuration of an objective lens assembly in accordance with an embodiment. Referring to FIG. 1, the objective lens assembly in accordance with the embodiment may include a refractive lens group 100, a focusing lens 200, and a catadioptric group 300.

The refractive lens group 100 may be aligned along an optical axis OA of the catadioptric group 300, i.e., centered along the z-axis. The refractive lens group 100 may include a plurality of refractive lenses. For example, the refractive lens group 100 may include a first refractive lens 110, a second refractive lens 120, a third refractive lens 130, a fourth refractive lens 140, a fifth refractive lens 150, a sixth refractive lens 160, and a seventh refractive lens 170.

The first refractive lens 110 may be spaced apart from the focusing lens 200 along the optical axis OA. The second refractive lens 120 may be located between the first refractive lens 110 and the focusing lens 200. The third refractive lens 130 may be located between the second refractive lens 120 and the focusing lens 200. The fourth refractive lens 140 may be located between the third refractive lens 130 and the focusing lens 200. The fifth refractive lens 150 may be located between the fourth refractive lens 140 and the focusing lens 200. The sixth refractive lens 160 may be located between the fifth refractive lens 150 and the focusing lens 200. The seventh refractive lens 170 may be located between the sixth refractive lens 160 and the focusing lens 200.

Table 1 shows radii of lens surfaces described in FIG. 1 and distances between adjacent lens surfaces in FIG. 1 following the ray trace shown by the dotted line in FIG. 1. Here, the distances between the adjacent lens surfaces may be measured along the optical axis OA of the catadioptric group 300.

TABLE 1

| Surface No. | Radius (mm) | Distance (mm) |
|---|---|---|
| 1 | Infinity | 5.000 |
| 2 | 69.365 | 3.000 |
| 3 | −42.548 | 1.000 |
| 4 | −23.240 | 3.006 |
| 5 | −196.468 | 1.000 |
| 6 | −1040.334 | 3.000 |
| 7 | −78.459 | 10.851 |
| 8 | −24.339 | 3.374 |
| 9 | −19.019 | 2.796 |
| 10 | 92.465 | 3.000 |
| 11 | 24.133 | 1.000 |
| 12 | 26.643 | 3.000 |
| 13 | 15.277 | 1.000 |
| 14 | 18.937 | 3.000 |
| 15 | −40.111 | 1.055 |
| 16 | 12.187 | 3.825 |
| 17 | 103.843 | 12.040 |
| 18 | Infinity | 27.509 |
| 19 | 54.480 | 18.245 |
| 20 | Infinity | −18.245 |
| 21 | 54.480 | −16.848 |
| 22 | 46.339 | −4.787 |
| 23 | 52.193 | 4.787 |
| 24 | 46.339 | 16.848 |
| 25 | 54.480 | 18.245 |
| 26 | Infinity | 0.990 |

Lens surface numbers (Surface No.) in Table 1 are given to a lens surface along a propagation path of light when the light propagates along the ray trace in FIG. 1. In an example embodiment, a left lens surface of the first refractive lens 110 is Surface No. 2 in Table 1. A right lens surface of the first refractive lens 110 is Surface No. 3 in Table 1. The first refractive lens 110 may be a bi-convex lens. Distance in Table 1 refers to a distance to the next lens surface according to the propagation path of light. For example, a distance between the left lens surface and the right lens surface of the first refractive lens 110, which is measured along the optical axis OA of the catadioptric group 300, is 3 mm. As discussed below, Surface No. 18 is the intermediate image MI.

Note that the ray trace for Surface Nos. 2 to 17 corresponds to lenses 110 to 200 aligned from left to right, the ray trace and Surface Nos. 19-26 in Table 1 do not correspond to lenses aligned from left to right. This is evident from the negative distances provided in Table 1. For example, light travels from Surface No. 18 to Surface No. 19, which is a left lens surface of a first catadioptric group lens 310. Surface No. 20 is the flat mirror 320, which reflect light back through the left lens surface of the first catadioptric group lens 310 (Surface No. 21) to a right lens surface of a second catadioptric group lens 340. Light is the incident on a hemispheric mirror 330 (Surface No. 22) is then reflected back through the second catadioptric group lens 340 (Surface No. 23) and is again is incident on the right lens surface of the first catadioptric group lens 310 (Surface No. 24), which it is transmitted from a left lens surface of the first catadioptric group lens 310 (Surface No. 25) to finally be incident on the target area TA (Surface No. 26).

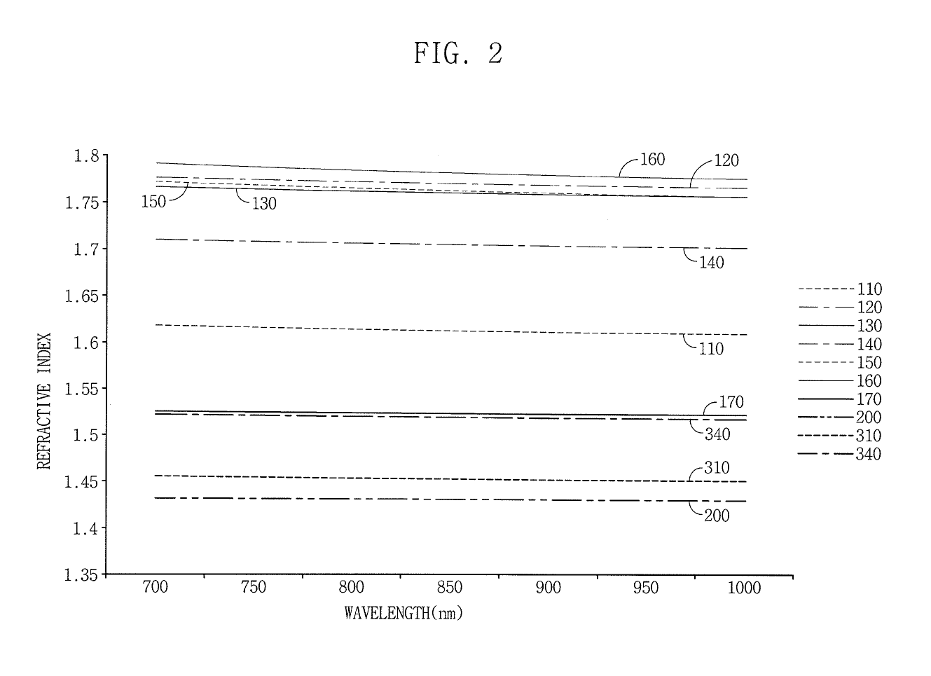

FIG. 2 shows line graph linking refractive indexes of each lens of an objective lens assembly in accordance with an embodiment according to wavelengths. Table 2 shows refractive indexes of each lens described in FIG. 2.

TABLE 2

| Lens No. | 700 nm | 800 nn | 900 nm | 1000 nm |
|---|---|---|---|---|
| 110 | 1.6182373 | 1.61393127 | 1.610858817 | 1.6085068 |
| 120 | 1.776451346 | 1.771805515 | 1.768373783 | 1.765642678 |
| 130 | 1.766092032 | 1.761945926 | 1.758858804 | 1.756383801 |
| 140 | 1.710308812 | 1.70642874 | 1.703581667 | 1.701335999 |
| 150 | 1.771923565 | 1.764890869 | 1.759965318 | 1.756263117 |
| 160 | 1.791736773 | 1.784360169 | 1.779212023 | 1.7753592 |
| 170 | 1.525415109 | 1.52355206 | 1.522157461 | 1.521035681 |
| 200 | 1.432135118 | 1.430856805 | 1.429880522 | 1.42907793 |
| 310 | 1.45267992 | 1.453293519 | 1.451730989 | 1.450395229 |
| 340 | 1.522145611 | 1.519706303 | 1.517822025 | 1.516249627 |

Referring to FIGS. 1 and 2 and table 2, ling graphs linking the refractive indexes of each of the first to seventh refractive lenses 110 to 170 of the refractive lens group 100 according to wavelengths may be different, e.g., at least one may be different up to all may be different. For example, in the objective lens assembly in accordance with the embodiment, light passing through a certain position of the first refractive lens 110 may be refracted differently according to the wavelength, i.e., the lenses exhibit dispersion. In addition, in the objective lens assembly in accordance with the embodiment, a certain wavelength of light passing through the first refractive lens 110 may be refracted differently than the same wavelength of light passing the seventh refractive lens 170. Thus, chromatic aberration may be compensated by the refractive lens group 100 in the objective lens assembly in accordance with the embodiment, e.g., the refractive lens group 100 may be designed to be substantially achromatic.

The focusing lens 200 may be located between the refractive lens group 100 and the catadioptric group 300. The focusing lens 200 may be located on the optical axis of the catadioptric group 300. The focusing lens 200 may be located adjacent to the refractive lens group 100. For example, the focusing lens 200 may be located adjacent to the seventh refractive lens 170.

The focusing lens 200 may generate an intermediate image MI using light transmitted from the refractive lens group 100. The intermediate image MI may be generated adjacent to the catadioptric group 300. In Table 1, Surface No. 18 may refer to the intermediate image MI generated by the focusing lens 200. The focusing lens 200 may increase the parallelism of the light transmitted from the catadioptric group 300.

The focusing lens 200 may include a first lens surface 200S1 and a second lens surface 200S2. The first lens surface 200S1 of the focusing lens 200 may face the refractive lens group 100. For example, the first lens surface 200S1 of the focusing lens 200 may face the seventh refractive lens 170. The first lens surface 200S1 of the focusing lens 200 may be Surface No. 16 in Table 1. The second lens surface 200S2 of the focusing lens 200 may be opposite to the first lens surface 20051 of the focusing lens 200. The second lens surface 200S2 of the focusing lens 200 may face the catadioptric group 300. The second lens surface 200S2 of the focusing lens 200 may be Surface No. 17 in Table 1.

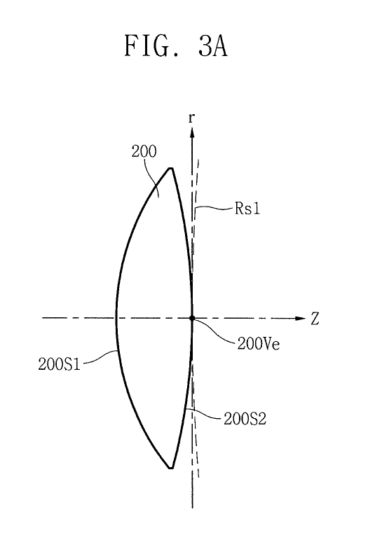

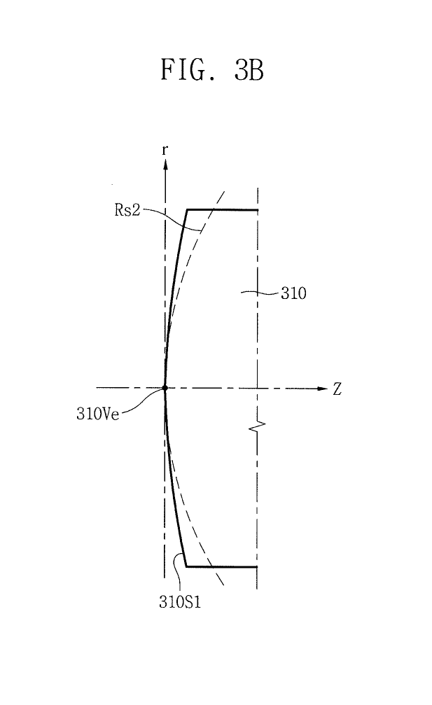

FIG. 3A is a view showing the focusing lens 200 of an objective lens assembly in accordance with an embodiment.

Referring to FIG. 3A and Table 1, a profile of the second lens surface 200S2 of the focusing lens 200 may be different from a shape Rs1 according to a radius described in Table 1. A radius of curvature of the second lens surface 200S2 in an edge portion of the focusing lens 200 may be different from a radius of curvature of the second lens surface 200S2 in a center portion of the focusing lens 200. For example, the second lens surface 200S2 of the focusing lens 200 may be an aspheric surface.

A profile of the second lens surface 200S2 of the focusing lens 200 may follow the Equation 1 below. A z-axis (Z) illustrated in FIG. 3A may pass through a vertex 200Ve of the second lens surface 200S2 of the focusing lens 200. For example, the z-axis illustrated in FIG. 3A may be the same as the optical axis OA of the catadioptric group 300 illustrated in FIG. 1.

$$Z ( r ) = \frac{{r}^{2}}{R ( 1 + \sqrt{1 - \frac{{r}^{2}}{{R}^{2}}} )} + {α}_{1} {r}^{2} + {α}_{2} {r}^{4} \qquad [ Equation 1 ]$$

Here, R is a radius of the second lens surface 200S2 of the focusing lens 200 listed in Table 1. That is, R is 103.843 mm, which is a radius of Surface No. 17 in Table 1. In Equation 1, α₁ and α₂ to obtain the profile of the second lens surface 200S2 of the focusing lens 200 may vary depending on the configuration of the refractive lens group 100. Referring to FIGS. 1 and 2, and Table 1, in the objective lens assembly in accordance with the embodiment, α₁ and α₂ to obtain the profile of the second lens surface 200S2 of the focusing lens 200 may be −0.024 and 0.0000315, respectively.

In the objective lens assembly in accordance with the embodiment, the focusing lens 200 disposed between the refractive lens group 100 and the catadioptric group 300 is described as an aspheric lens. Thus, monochromatic aberration may be compensated between the refractive lens group 100 and the catadioptric group 300 in the objective lens assembly in accordance with the embodiment. That is, conditions to be considered for compensating aberration may be minimized in the objective lens assembly in accordance with the embodiment.

In the objective lens assembly in accordance with the embodiment, only the second lens surface 200S2 of the focusing lens 200 is described as an aspheric surface. However, both the first lens surface 200S1 and the second lens surface 200S2 of the focusing lens 200 may be aspheric surfaces.

Referring to FIG. 2, in the objective lens assembly in accordance with the embodiment, the line graph linking refractive indexes of the focusing lens 200 according to wavelengths may be different from a line graph refractive indexes, e.g., one, two, or all, of the first to seventh refractive lenses 110 to 170 according to wavelengths. That is, in the objective lens assembly in accordance with the embodiment, the degree of refraction according to a location and wavelength of light passing through the focusing lens 200 may be different from the degree of refraction according to a location and wavelength of light passing through one or more of the first to seventh refractive lenses 110 to 170. Thus, chromatic aberration may be compensated by the first to seventh refractive lenses 110 to 170 and the focusing lens 200 of the objective lens assembly in accordance with the embodiment.

FIG. 3B is a view partially showing a first catadioptric group lens of an objective lens assembly in accordance with an embodiment.

Referring to FIGS. 1 and 3B, and Table 1, the catadioptric group 300 may be located between the focusing lens 200 and the target area TA. The target area TA may be located on the optical axis OA of the catadioptric group 300. The catadioptric group 300 may illuminate the target area TA with light transmitted from the focusing lens 200. The catadioptric group 300 may increase resolution of an image of the target area TA using light reflected from the target area TA.

The catadioptric group 300 may include the first catadioptric group lens 310, the flat mirror 320, the hemispheric mirror 330, and the second catadioptric group lens 340.

The first catadioptric group lens 310 may include a first lens surface 310S1 and a second lens surface 31052. The first lens surface 310S1 of the first catadioptric group lens 310 may face the refractive lens group 100. The first lens surface 310S1 of the first catadioptric group lens 310 may face the second lens surface 200S2 of the focusing lens 200. The second lens surface 310S2 of the first catadioptric group lens 310 may be opposite to the first lens surface 310S1 of the first catadioptric group lens 310.

Light transmitted from the focusing lens 200 may be transmitted to the first lens surface 310S1 of the first catadioptric group lens 310 without passing through the hemispheric mirror 330 and the second catadioptric group lens 340. The first lens surface 310S1 of the first catadioptric group lens 310 may be Surface No. 19 in the Table 1. The first lens surface 310S1 of the first catadioptric group lens 310 may have a convex shape bulged toward the focusing lens 200. The second lens surface 310S2 of the first catadioptric group lens 310 may be Surface No. 20 in Table 1. The second lens surface 31052 of the first catadioptric group lens 310 may be a flat shape. For example, the first catadioptric group lens 310 may be a plano-convex lens.

A profile of the first lens surface 310S1 of the first catadioptric group lens 310 may be different from a shape Rs2 according to a radius listed in the Table 1. A radius of curvature of the first lens surface 310S1 in an edge portion of the first catadioptric group lens 310 may be different from a radius of curvature of the first lens surface 310S1 in a center portion of the first catadioptric group lens 310. For example, the first lens surface 310S1 of the first catadioptric group lens 310 may be an aspheric surface.

The profile of the first lens surface 310S1 of the first catadioptric group lens 310 may follow Equation 1. A z-axis illustrated in FIG. 3B may pass through a vertex 310Ve of the first lens surface 310S1 of the first catadioptric group lens 310. For example, the z-axis illustrated in FIG. 3B may be the same as the optical axis OA of the catadioptric group 300 illustrated in FIG. 1.

In Equation 1, α₁ and α₂ to obtain the profile of the first lens surface 310S1 of the first catadioptric group lens 310 may vary depending on the configuration of the refractive lens group 100 and the shape of the second lens surface 200S2 of the focusing lens 200. Referring to FIGS. 1, 2, and 3A, and Table 1, in the objective lens assembly in accordance with the embodiment, α₁ and α₂ to obtain the profile of the first lens surface 310S1 of the first catadioptric group lens 310 may be −0.003229 and −0.000002704, respectively.

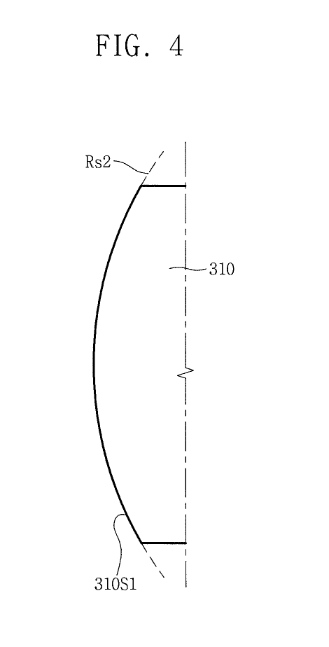

In the objective lens assembly in accordance with the embodiment, the first lens surface 310S1 of the first catadioptric group lens 310 that faces the second lens surface 200S2 of the focusing lens 200 is described as an aspheric surface. Thus, in the objective lens assembly in accordance with the embodiment, monochromatic aberration may be complementarily compensated by the focusing lens 200 and the first catadioptric group lens 310. However, in an objective lens assembly in accordance with another embodiment, the first lens surface 310S1 of the first catadioptric group lens 310 may be a spherical surface, as shown in FIG. 4. For example, the profile of the first lens surface 310S1 of the first catadioptric group lens 310 may be the same as the shape Rs2 according to the radius listed in Table 1.

The flat mirror 320 may be located between the first catadioptric group lens 310 and the target area TA. The flat mirror 320 may be disposed on the second lens surface 310S2 of the first catadioptric group lens 310. The flat mirror 320 may reflect light directed toward a periphery of the target area TA. The flat mirror 320 may be in direct contact with the second lens surface 310S2 of the first catadioptric group lens 310.

The hemispheric mirror 330 may be located on the first lens surface 310S1 of the first catadioptric group lens 310. The hemispheric mirror 330 may be located between the focusing lens 200 and the first catadioptric group lens 310. The hemispheric mirror 330 may be spaced apart from the first catadioptric group lens 310.

The hemispheric mirror 330 may reflect back the light reflected by the flat mirror 320 toward the target area TA. The hemispheric mirror 330 may reflect back the light reflected by the target area TA toward the flat mirror 320. The hemispheric mirror 330 may be a hemispherical shape bulged toward the focusing lens 200.

The second catadioptric group lens 340 may be located between the first catadioptric group lens 310 and the hemispheric mirror 330. The second catadioptric group lens 340 may be in direct contact with a reflective surface of the hemispheric mirror 330 facing the first catadioptric group lens 310. For example, the second catadioptric group lens 340 may be a meniscus lens bulged toward the focusing lens 200.

Referring to FIG. 2, in the objective lens assembly in accordance with an embodiment, a line graph linking refractive indexes of the first catadioptric group lens 310 according to wavelengths may be different from a line graph linking refractive indexes of the second catadioptric group lens 340 according to wavelengths. In addition, in the objective lens assembly in accordance with the embodiment, the line graph linking the refractive indexes of the first catadioptric group lens 310 according to wavelengths and the line graph linking the refractive indexes of the second catadioptric group lens 340 according to wavelengths may be different from the line graphs linking the refractive indexes of the first to seventh refractive lenses 110 to 170 according to wavelengths and the line graphs linking the refractive indexes of the focusing lens 200 according to wavelengths.

As a result, in the objective lens assembly in accordance with the embodiment, the focusing lens 200 located between the refractive lens group 100 and the catadioptric group 300 may be an aspheric lens. In addition, in the objective lens assembly in accordance with the embodiment, the line graph linking the refractive indexes of the focusing lens 200 according to wavelengths may be different from the line graphs linking the refractive indexes of the first to seventh refractive lenses 110 to 170 of the refractive lens group 100 according to wavelengths and the line graph linking the refractive indexes of for the first and second catadioptric lenses 310 and 340 of the catadioptric group 300 according to wavelengths. Accordingly, chromatic aberration and monochromatic aberration may be effectively compensated in the objective lens assembly in accordance with the embodiment.

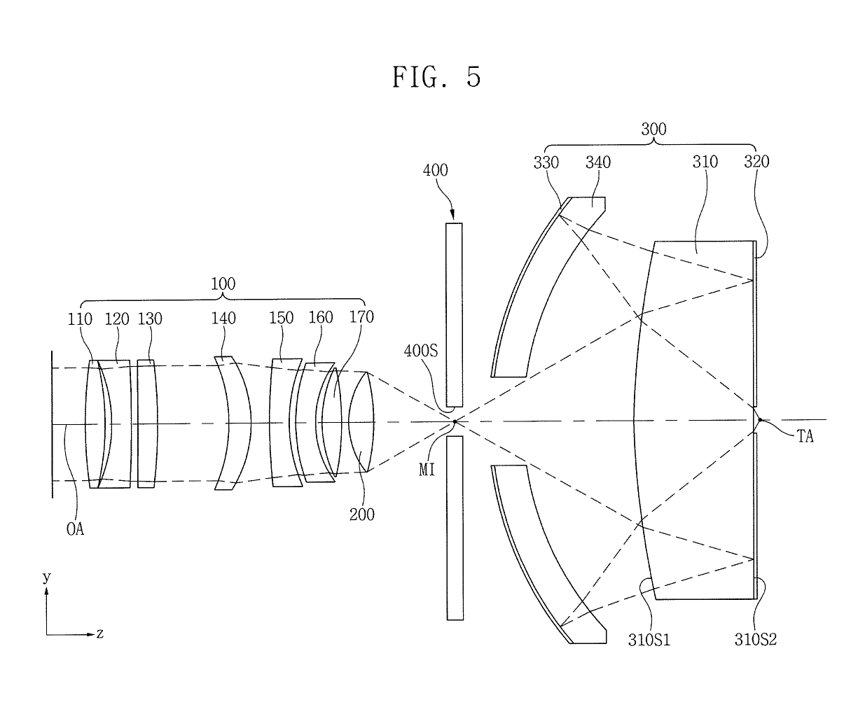

FIG. 5 is a view showing a schematic configuration of an objective lens assembly in accordance with an embodiment. Referring to FIG. 5, the objective lens assembly in accordance with the embodiment may include the refractive lens group 100, the focusing lens 200, the catadioptric group 300, and a slit plate 400.

The refractive lens group 100 may include the first refractive lens 110, the second refractive lens 120, the third refractive lens 130, the fourth refractive lens 140, the fifth refractive lens 150, the sixth refractive lens 160, and the seventh refractive lens 170 may be located on an optical axis OA of the catadioptric group 300.

The focusing lens 200 may be located between the refractive lens group 100 and the catadioptric group 300. The focusing lens 200 may be an aspheric lens. For example, a lens surface of the focusing lens 200 facing the catadioptric group 300 may be an aspheric surface.

The catadioptric group 300 may be located between the focusing lens 200 and a target area TA. The catadioptric group 300 may include the first catadioptric group lens 310, the flat mirror 320, the hemispheric mirror 330, and the second catadioptric group lens 340. The first catadioptric group lens 310 may be a plano-convex lens including a convex lens surface facing the focusing lens 200 and a flat lens surface opposite to the convex lens surface. The first catadioptric group lens 310 may be an aspheric lens. The second catadioptric group lens 340 may be a meniscus lens in contact with the hemispheric mirror 330.

The slit plate 400 may be located between the focusing lens 200 and the catadioptric group 300. The slit plate 400 may include a slit 400s. The slit 400s of the slit plate 400 may be located on the optical axis OA of the catadioptric group 300. An intermediate image MI generated between the focusing lens 200 and the catadioptric group 300 may pass through the slit 400s of the slit plate 400 to be transmitted. For example, the intermediate image MI may be generated in the slit 400s of the slit plate 400.

In the objective lens assembly in accordance with the embodiment, the intermediate image MI generated between the focusing lens 200 and the catadioptric group 300 may pass through the slit 400s of the slit plate 400. Therefore, in the objective lens assembly in accordance with the embodiment, distortion of the intermediate image MI may be prevented by the slit plate 400. Thus, chromatic aberration and monochromatic aberration may be effectively compensated in the objective lens assembly in accordance with the embodiment concept.

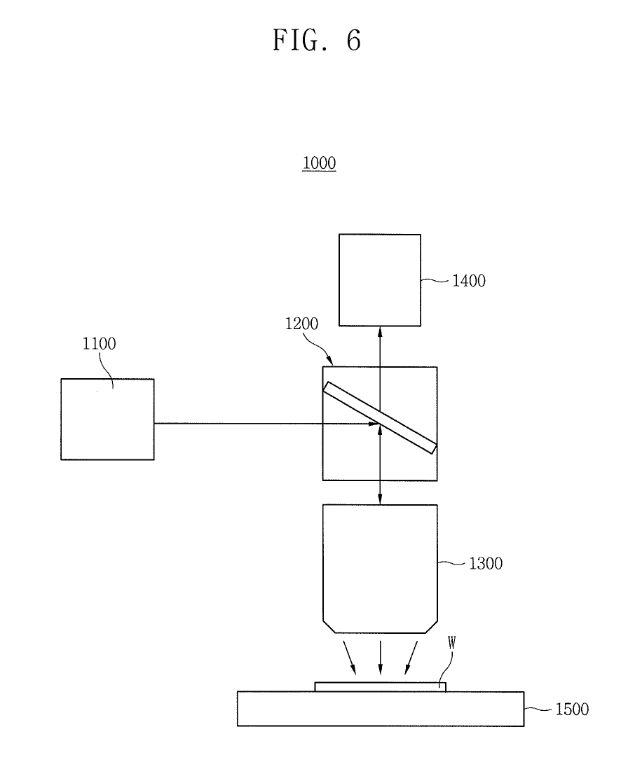

FIG. 6 is a view showing a schematic configuration of an optical device including an objective lens assembly in accordance with an embodiment.

Referring to FIG. 6, an optical device 1000 in accordance with an embodiment may include a light source member 1100, a beam splitter 1200, an inspection optical system 1300, a detector 1400, and a stage member 1500. The optical device 1000 may be an optical measurement apparatus for measuring a surface of a wafer. The optical device 1000 may be an optical inspection apparatus for inspecting a surface defect of a wafer.

The light source member 1100 may illuminate a wafer W with light by the beam splitter 1200 and the inspection optical system 1300. The beam splitter 1200 may reflect light of the light source member 1100 toward the wafer W. The beam splitter 1200 may transmit the light reflected by the wafer W. The inspection optical system 1300 may focus the light reflected by the beam splitter 1200 on the wafer W. The light reflected by the wafer W may pass through the beam splitter 1200 by the inspection optical system 1300.

The inspection optical system 1300 may include an objective lens assembly in accordance with an embodiment. Therefore, optical aberrations, such as chromatic aberration and monochromatic aberration, in a surface image of the wafer W may be effectively compensated in the inspection optical system 1300. That is, the inspection optical system 1300 may transfer a clear surface image of the wafer W to the detector 1400. Thus, reliability in measurement or inspection may be improved in the optical device 1000.

The detector 1400 may measure a surface morphology of the wafer W using the reflected light of the wafer W. The detector 1400 may check a defect of a pattern formed on the wafer W using the reflected light of the wafer W. The stage member 1500 may support the wafer W. The wafer W may be fixed on the stage member 1500.

The objective lens assembly in accordance with the embodiments may be effectively configured as a focusing lens and refractive lenses on an optical axis of a catadioptric group. Thus, chromatic aberration and monochromatic aberration may be effectively compensated in the objective lens assembly in accordance with the embodiment.

More generally, a lens assembly may includes a first lens group increasing resolution of an image of a target area, a second lens group axially aligned with the first lens group and compensating chromatic aberration, and an aspheric lens located between the first lens group and the second lens group.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An objective lens assembly, comprising:
a catadioptric group;
a first refractive lens axially aligned with the catadioptric group; and
a focusing lens aligned with and between the catadioptric group and the first refractive lens,
wherein the focusing lens is an aspheric lens.

2. The objective lens assembly as claimed in claim 1, wherein the focusing lens includes a first lens surface facing the first refractive lens and a second lens surface facing the catadioptric group, wherein the second lens surface is an aspheric surface.

3. The objective lens assembly as claimed in claim 1, wherein a line graph linking refractive indexes of the first refractive lens according to wavelengths is different from a line graph linking refractive indexes of the focusing lens according to the wavelengths.

4. The objective lens assembly as claimed in claim 3, wherein a material of the first refractive lens is different from a material of the focusing lens.

5. The objective lens assembly as claimed in claim 3, further comprising a second refractive lens disposed between the first refractive lens and the focusing lens,
wherein a line graph linking refractive indexes of the second refractive lens according to wavelengths is different from the line graph linking the refractive indexes of the first refractive lens according to wavelengths.

6. The objective lens assembly as claimed in claim 5, wherein the line graph linking the refractive indexes of the second refractive lens according to wavelengths is different from the line graph linking the refractive indexes of the focusing lens according to wavelengths.

7. The objective lens assembly as claimed in claim 1, wherein the catadioptric group includes a flat mirror spaced apart from the focusing lens, a hemispherical mirror between the focusing lens and the flat mirror, and a first catadioptric group lens between the flat mirror and the hemispherical mirror, wherein the first catadioptric group lens is an aspheric lens.

8. The objective lens assembly as claimed in claim 7, wherein a line graph linking refractive indexes of the first catadioptric group lens according to wavelengths is different from the line graph linking refractive indexes of the focusing lens according to wavelengths.

9. The objective lens assembly as claimed in claim 7, wherein the catadioptric group further comprises a second catadioptric group lens between the hemispherical lens and the first catadioptric lens.

10. The objective lens assembly as claimed in claim 9, wherein the second catadioptric group lens is in direct contact with a reflective surface of the hemispherical mirror facing the first catadioptric lens.

11. The objective lens assembly as claimed in claim 9, wherein a line graph linking refractive indexes of the second catadioptric group lens according to wavelengths is different from the line graph linking the refractive indexes of the first catadioptric group lens according to wavelengths.

12. The objective lens assembly as claimed in claim 11, wherein the line graph linking the refractive indexes of the second catadioptric group lens according to wavelengths is different from the line graph linking the refractive indexes of the focusing lens according to wavelengths.

13. An objective lens assembly, comprising:
a focusing lens including a first lens surface and a second lens surface opposite to the first lens surface;
a refractive lens group including refractive lenses facing the first lens surface of the focusing lens; and
a catadioptric group facing the second lens surface of the focusing lens,
wherein a radius of curvature of the second lens surface in an edge portion of the focusing lens is different from a radius of curvature of the second lens surface in a center portion of the focusing lens.

14. The objective lens assembly as claimed in claim 13, a radius of curvature of the first lens surface in the edge portion of the focusing lens is the same as a radius of curvature of the first lens surface in the center portion of the focusing lens.

15. The objective lens assembly as claimed in claim 13, wherein the catadioptric group includes:
a plano-convex lens having a convex lens surface facing the second lens surface of the focusing lens and a flat lens surface opposite to the convex lens surface;
a flat mirror disposed on the flat lens surface of the plano-convex lens; and
a hemispherical lens disposed between the focusing lens and the convex lens surface of the plano-convex lens,
wherein a radius of curvature of the convex lens surface in an edge portion of the plano-convex lens is different from a radius of curvature of the convex lens surface in a center portion of the plano-convex lens.

16. An objective lens assembly, comprising:
a catadioptric group increasing resolution of an image of an objective area;
a refractive lens group compensating chromatic aberration, the refractive lens group axially aligned with the catadioptric group; and
a first aspheric lens aligned with and between the catadioptric group and the refractive lens group.

17. The objective lens assembly as claimed in claim 16, wherein at least one lens in the catadioptric group has a first refractive index, at least one lens of the refractive lens group has a second refractive index, and the first aspheric lens has a third refractive index, the first to third refractive indexes being different over the wavelength range.

18. The objective lens assembly as claimed in claim 16, wherein the refractive lens group includes at least two refractive lenses, at least two refractive lenses of the refractive lens group having different refractive indexes over the wavelength range.

19. The objective lens assembly as claimed in claim 16, at least one surface of a lens of the catadioptric group is aspheric.

20. The objective lens assembly as claimed in claim 19, wherein an aspheric surface of the focusing lens faces an aspheric surface of the catadioptric group.
